(19) United States
(12) Patent Application Publication
(10) Pub. No.: US 2011/0107422 A1
(43) Pub. Date: May 5, 2011

(54) EMAIL WORM DETECTION METHODS AND DEVICES

(76) Inventors: Patrick Choy Ming Wong, Roseville, CA (US); Michael Todd, Roseville, CA (US)

(21) Appl. No.: 12/609,490

(22) Filed: Oct. 30, 2009

(51) Int. Cl. G06F 11/00

(52) U.S. Cl. 726/23; 714/48; 714/E11.004

(57) ABSTRACT

Embodiments of the invention provide a network device for detecting email worms having a port for receiving packets and a processing engine configured to inspect packets received on the port, wherein if a predetermined number of packets sent from a client represent DNS queries, the client is identified as being infected.

### TECHNICAL FIELD

Embodiments of the present invention relate generally to computer network technology, and more particularly to worm detection in such networks.

### BACKGROUND

A computer worm is a self-propagating computer program, which is often designed to cause harm to a computer and/or a computer network. Unlike a virus, a worm does not need to attach itself to an existing program. Instead, a computer worm self-propagates by sending copies of itself from one node to another (e.g., from one computer to another) over a network. Such transmissions can occur without any user intervention, thereby allowing them to be spread quickly and easily.

Depending on the type of worm that infiltrates a network, varying degrees of damage can result. Common types of damage include bandwidth clogging and general loss of system productivity. As a result, a substantial amount of money is often spent preventing and/or fixing worm attacks, including for example help desk support costs, overtime pay, contingency outsourcing, management time reallocation, system recovery, and software updates.

Computer worms are one of the most challenging problems facing computer security researchers today. The value of a computer network is a function of its speed and the number of connected devices making up the network. However, fast and large networks enable computer worms to propagate rapidly and cause more damage.

Examples of some notorious computer worms include those commonly referred to as “MyDoom,” “Mytob,” and “Netsky.” These three worms are often identified by the major anti-virus vendors as being extremely high threats. Recent reports suggest that MyDoom caused over $37 Billion in damages though 2008. While Mytob and NetSky have not caused the same degree of monetary damages, they are highly prevalent, together representing approximately 50% of all worm infiltrations reported during 2006. While these worms are some of the more notable ones, they represent only a small percentage of malicious worms known in the industry. Indeed, there are thousands of known malicious worms with new ones being created on a regular basis.

Computer worms are generally categorized as either network worms or email worms. Network worms are typically sent blindly to multiple clients over a network protocol by using a broadcast transmission. To the contrary, email worms are not sent to several clients simultaneously, but rather are sent directly from one client to another. Email worms operate by installing a local Simple Mail Transfer Protocol (“SMTP”) engine on an infected host, which will then attempt to send out a massive number of emails to a wide range of systems across the Internet. In either case, worms can spread quickly and easily.

Network worms are generally easier to detect as they typically cause unusual network activity. As such, algorithms can be used to detect unusual traffic patterns indicating presence of a network worm. For example, a network device monitoring the network could trigger an alert whenever one client sends packets simultaneously to several other clients. Such activity is identified because it does not reflect common network usage. Indeed, with certain notable exceptions (e.g., administrative diagnostics), packets are generally not broadcast to several clients at once.

Emails worms are generally more difficult to detect since they generally mimic traditional user behavior (e.g., browsing the internet or sending an email). One common approach to detect email worms is to use signature files, which scan network traffic and compare it to known email worm signatures. However, this method relies on the availability of updated signature files. As such, this approach is often ineffective at protecting against new worms which can spread within seconds (before an appropriate signature can be created).

Other known methods of detecting email worms include network diagnostics by network administrators (e.g., reviewing reports of data associated with select network parameters) to determine if such worms are present. However, since worms can self-propagate and often become widespread in a matter of minutes, detection methods requiring significant human interaction are impractical and ineffective.

### BRIEF DESCRIPTION OF THE DRAWINGS

FIG. 1 is a first preferred embodiment of the network device of the present invention;

FIG. 2 is a flowchart depicting a method of a first preferred embodiment of the present invention;

FIG. 3 is a flowchart depicting a method of a second preferred embodiment of the present invention;

FIG. 4 is a graph showing DNS packet rates for an uninfected client in a testing environment;

FIG. 5 is a graph showing DNS packet rates for client infected with a Mydoom worm in a testing environment;

FIG. 6 is a graph showing DNS packet rates for client infected with a Mytob worm in a testing environment; and

FIG. 7 is a graph showing DNS packet rates for client infected with a Netsky worm in a testing environment.

### DETAILED DESCRIPTION

Throughout this specification, all references to “a,” “an,” or “the” refer to at least one unless otherwise specified. Embodiments of the invention provide a network device which identifies email worms based on a particular client's query activity with a Domain Name System (DNS) server. DNS servers act as a telephone directory for the Internet to allow computers to translate a hostname (e.g., abc.com) to an Internet Protocol (“IP”) address (e.g., 15.200.30.22), which is a numerical label assigned to a device participating in a computer network, and which utilizes the established IP for communication between nodes. Ultimately, computers use IP addresses to locate and communicate with other computers over a network.

When an email worm is sent (i.e., as it self-propagates), the SMTP engine performs a DNS query to resolve the destination mail's IP server. This type of query is known as a mail exchange or MX query. In a typical environment, MX queries are made by mail servers, which use the resolved data to facilitate email delivery. However, since email worms are intended to be self-propagating, email worms are designed to cause the MX query to be initiated by the client. As such, instances of MX queries initiated from a client (rather than a mail server) provide an indication that an email worm is being propagating through the network to one or likely many other clients. Therefore, embodiments of the present invention provide for detection of email worms by identifying client-initiated MX query activity.

Notably, there are instances where MX queries are initiated by a client for legitimate purposes. For example, a system administrator can use a client-initiated MX query to perform diagnostic activities related to the client, network, and/or other devices (e.g., to test accessibility of a DNS server). Therefore, to reduce the number of potential false-positive identifications of email worms, the present invention also provides for detection of email worms by analyzing a number of DNS queries initiated by a client.

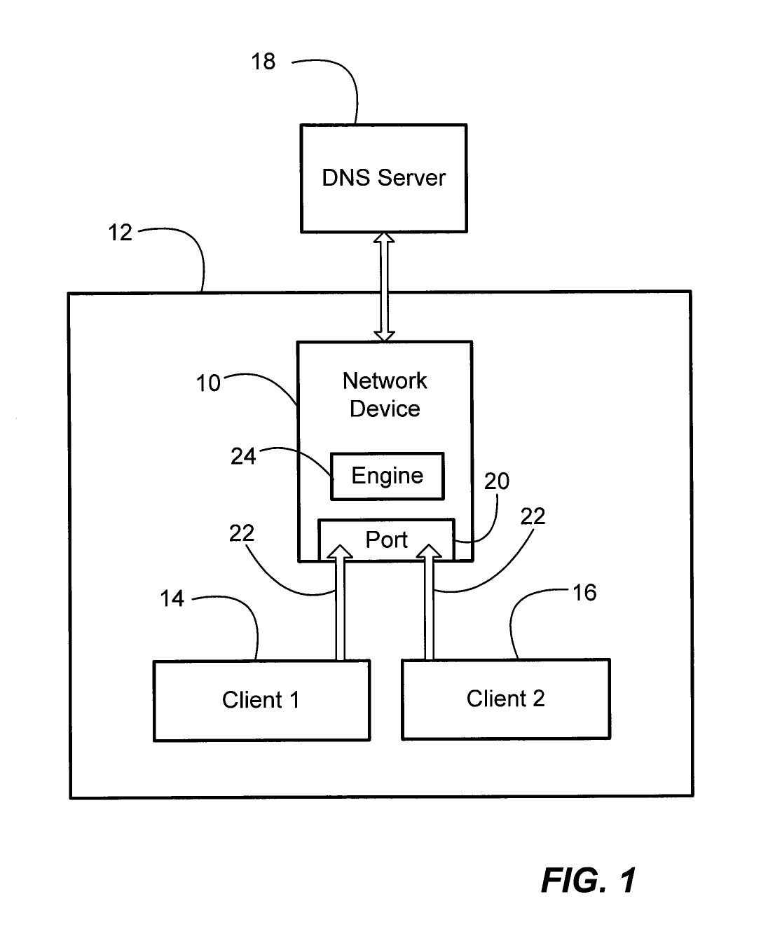

As shown in FIG. 1, in a first preferred embodiment of the present invention, a network device 10 is shown as part of a network 12, which further includes at least two client computers 14, 16. A DNS server 18 is shown outside the network 12 (although its location is not so limited). Notably, typical networks include additional components and increased complexity. However, for the sake of clarity, a stripped down version of a network is shown. Further, it is noted that the present invention is not limited to the network arrangement and configuration as depicted in the embodiment of FIG. 1. Indeed, alternate embodiments are contemplated which do not depart from the present invention.

Returning to the first preferred embodiment of FIG. 1, included on the network device 10 is a port 20 configured for receiving packets 22, including for example packets 22 sent from client computers 14, 16. The network device 10 also includes a processing engine 24, which is configured to carryout operations related to the network device. The processing engine 24 can be implemented using, among other things, hardware, software (i.e., instructions stored on a computer-readable medium), or a combination of both.

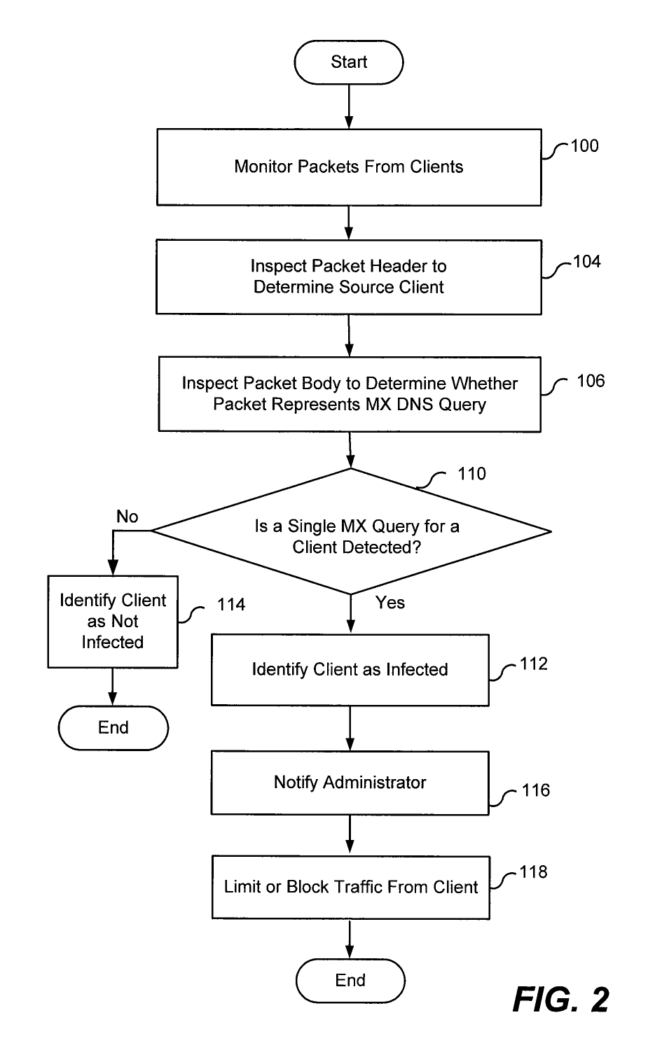

Referring now to FIG. 2, the operational steps associated with the first preferred embodiment of the present invention are shown and described in further detail below. As packets 22 are received on the port 20 of the network device 10, the processing engine 24 monitors the packets (step 100) such that it tracks the number of packets representing DNS queries sent from each client 14, 16 (step 102). Determining which client 14, 16 sent a given packet 22 is accomplished by decoding and inspecting a header of the packet 22 (step 104) which contains, among other things, an identification of the packet's source (e.g., its IP address). As known to those in the art, packets typically contain both a header portion and a body portion. The header contains information generally relating to the transmission of the packet such as its source IP address as described above, while the body contains the actual data being transmitted. As in the present case, if a packet represents a query, data representing the actual query being made is contained in the body of the packet.

The body of the packet 22 is then inspected (step 106) (commonly referred to as deep packet inspection), to determine whether the packet represents an MX-type DNS query. This is done by looking for a particular pattern associated with an MX query in the packet body, wherein the pattern is designed to identify particular characteristics of the data. Once the deep packet inspection has been performed, the network device 10 can determine the number of MX type DNS queries, which were initiated directly by each client 14, 16 residing in the network 12.

In the first preferred embodiment, determining that a predetermined threshold number of instances of an MX query initiated by a client is an indication that the client is infected with an email worm. Therefore, if the processing engine 24 detects the threshold number of MX queries for a client 14, 16 (step 110), the client is identified as being infected (step 112). Otherwise, the client 14, 16 is identified as being uninfected (i.e., not containing a self-propagating worm) (step 114). Notably, the threshold number of MX queries detected by the processing engine 24 is adjustable and can be set depending on a desired tolerance of the system. Notably, while increasing the threshold level could potentially result in overlooking the presence of an email worm, it also reduces the number of potential false-positives. As described above, certain network diagnostic techniques generate legitimate MX queries, which should not identify the client 14, 16 as being infected. As such, the threshold number should be set (e.g., by a system administrator) depending on the characteristics of the network and the desired tolerance level. Notably, the threshold number can be as low as one. While such a threshold number could result in a large number of false-positives, it would likely identify every client infected with even a single email worm.

When a particular client 14, 16 is identified as being infected, a notification is sent to a predetermined address (e.g., one corresponding to a system administrator) containing any information relevant to the infection (step 116), including for example an identification of the particular client 14, 16, which is infected, along with the number and type of DNS queries initiated from the infected client. Further, the processing engine 24 then either limits or blocks (step 118) traffic originating from the infected client so as to avoid the spread of the email worm.

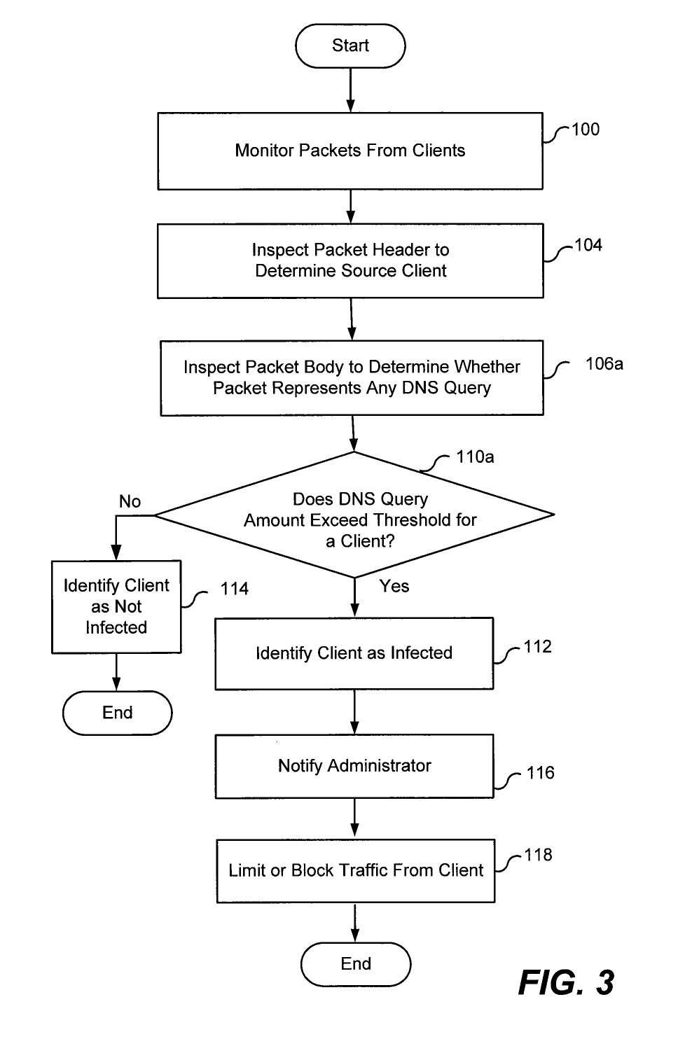

Turning now to FIG. 3, in a second preferred embodiment, the network device 10 performs the same steps as described above with respect to the first preferred embodiment, except that the processing engine 24 does not monitor for a specific number of MX-type DNS queries, but rather monitors for abnormal levels of any type of DNS query (e.g., MX, C_name, PTR) (step 106a). The modified monitoring technique requires less complexity with respect to the packet inspection since the processing engine is searching for comparably less data. As such, the modified monitoring technique reduces use of processing time and system resources. However, under this approach, in addition to the false positive MX queries, there are now other types of DNS queries that can result in false-positives being identified. As such, the processing engine 24 uses a comparison technique to compare DNS queries initiated by a particular client 14, 16 with a predetermined threshold number (step 110a) to determine whether the client is infected. The numbers being compared are represented as a rate of packets per second, although other embodiments can be employed which consider other measurements (e.g., raw number of DNS queries initiated, etc.).

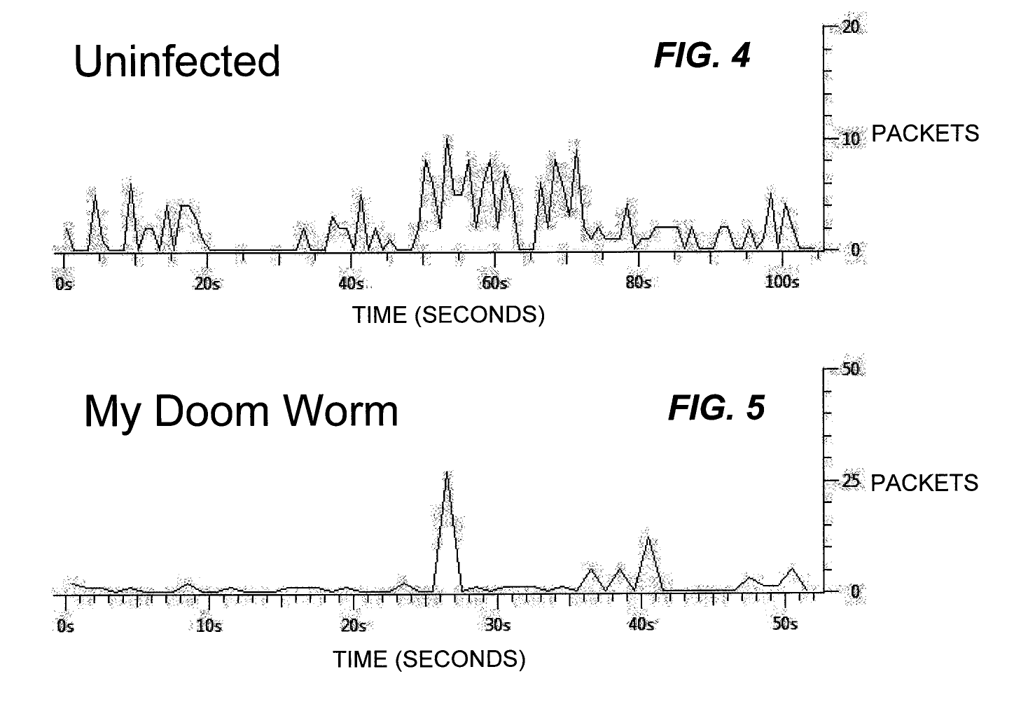

The threshold number is predetermined (e.g., by a system administrator) and is preferably based on particular client and/or network test results. FIGS. 4-7 depict graphs of the rate of DNS queries in packets per second (pps), which were initiated from four separate clients in a testing environment. In each graph, the x-axis represents time in seconds, while the y-axis represents the number of packets.

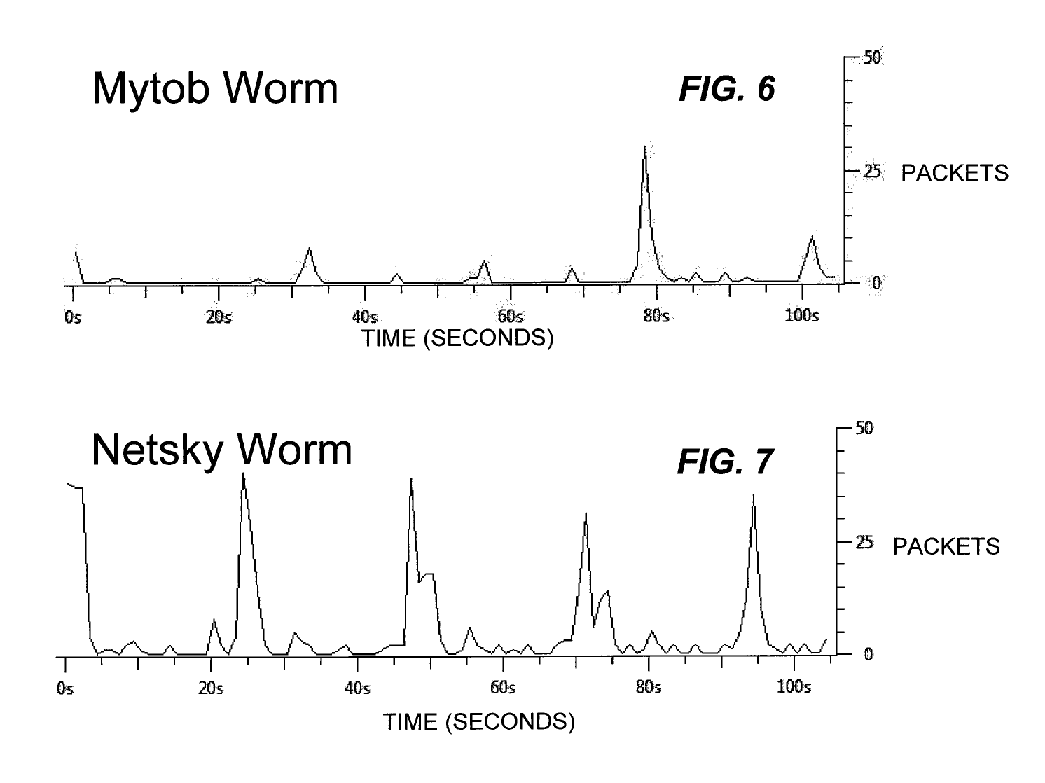

FIG. 4 was taken from a client known to be uninfected. Notably, the rate of DNS queries peaks at approximately 10 pps. FIG. 5 represents DNS query activity for a client infected with the Mydoom email worm, FIG. 6 represents DNS query activity for a client infected with the Mytob email worm, and FIG. 7 represents DNS query activity for a client infected with the Netsky email worm. Notably, the rate of DNS queries for each of the infected systems exceeds approximately 25 pps. Therefore, based on these results, a system administrator would likely set the predetermined threshold number within the range of 10-25 pps. Such a range would allow the processing engine 24 to identify clients infected with the worms described above, while not returning a false-positive for the uninfected client. Adjustments within this defined range would reflect a desired tolerance of the system administrator. As described in further detail above, the predetermined threshold number is adjustable and can be specifically tailored to a particular network and/or known email worm threat levels.

In preferred embodiments of the present invention, the network device is a network switch since switches are likely to receive all network traffic originating from the clients on the network and therefore is in an appropriate location to effectively monitor packets. However, any network device configured to receive packets is also contemplated and could be used instead of a network switch. Further, it is noted that the steps described above could be performed by a network device stationed outside the network, provided there is some communication to the packets being sent from the networked clients so as to facilitate the desired packet monitoring.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A network device for detecting email worms, comprising:
a port for receiving packets; and
a processing engine configured to inspect packets received on said port, wherein if a predetermined number of packets sent from a client represent DNS queries, the client is identified as being infected.

2. The network device of claim 1 wherein said predetermined number of packets is at least one packet and said DNS queries are mail exchange DNS queries.

3. The network device of claim 1 wherein said predetermined number of packets is represented as a rate of packet traffic activity.

4. The network device of claim 3 wherein said rate is at least twenty-five packets per second.

5. The network device of claim 1 wherein if the client is identified as being infected, a notification is sent to at least one predetermined address.

6. The network device of claim 1 wherein if the client is identified as being infected, said network device limits the number of packets sent from the client.

7. The network device of claim 1 wherein if the client is identified as being infected, said network device blocks packets sent from the client.

8. A method of detecting an email worm using a network device, comprising the steps of:
a network device monitoring packets sent from a client on a network;
the network device counting a number of packets representing DNS queries sent from the client;
the network device comparing the number of packets to a predetermined threshold number; and
if the number of packets is at least the predetermined threshold number, the network device identifying the client as being infected.

9. The method of claim 8 wherein said predetermined number of packets is at least one packet and said DNS queries are mail exchange DNS queries.

10. The method of claim 8 wherein said predetermined number of packets is represented as a rate of packet traffic activity.

11. The method of claim 10 wherein the rate is twenty-five packets per second.

12. The method of claim 8, further comprising the step of:
if the client is identified as being infected, the network device sending a notification to a system administrator.

13. The method of claim 8, further comprising the step of:
if the client is identified as being infected, the network device limiting the number of packets sent from the client.

14. A computer-readable medium associated with a network device, containing instructions for executing the steps of:
monitoring packets sent from a client on a network;
counting a number of packets representing DNS queries sent from the client;
comparing the number of packets to a predetermined threshold number; and
if the number of packets is at least the predetermined threshold number, identifying the client as being infected.

15. The computer-readable medium of claim 14 wherein the predetermined number of packets is at least one packet and said DNS queries are mail exchange DNS queries.

16. The computer-readable medium of claim 14 wherein said predetermined number of packets is represented as a rate of packet traffic activity.

17. The computer-readable medium of claim 16 wherein said rate is at least twenty-five packets per second.

18. The computer-readable medium of claim 14 wherein if the client is identified as being infected, a notification is sent to at least one predetermined address.

19. The computer-readable medium of claim 14 wherein if the client is identified as being infected, said network device limits the number of packets sent from the client.

20. The computer-readable medium of claim 14 wherein if the client is identified as being infected, said network device blocks packets sent from the client.
